(19) United States
(12) Patent Application Publication
(10) Pub. No.: US 2026/0246830 A1
(43) Pub. Date: Aug. 20, 2026

(54) COMPUTATIONAL RESOURCE DISCOVERY FOR OFFLOADING PROCESSING UPON REQUEST

(71) Applicant: Arm Limited, Cambridge (GB)

(72) Inventors: Eric Van Hensbergen, Austin, TX (US); Pavel Shamis, Austin, TX (US); Luis Emilio Pena, Austin, TX (US); Vasileios Laganakos, Saffron Walden (GB)

(73) Assignee: Arm Limited, Cambridge (GB)

(21) Appl. No.: 19/110,745

(22) PCT Filed: Sep. 6, 2023
(86) PCT No.: PCT/GB2023/052301

§ 371 Date: Mar. 11, 2025

(30) Foreign Application Priority Data
Sep. 15, 2022 (EP) 22386063.6

(51) Int. Cl. H04L 67/1012; H04L 67/1023

(52) U.S. Cl. CPC H04L 67/1012; H04L 67/1023

(57) ABSTRACT

A method of operating a network-reachable initiator computing entity, comprising: determining a requirement, at the initiator computing entity, for offloading data processing; initiating a message, to be sent on a network to a destination, requesting a response from network-reachable recipient computing entities along the network, from the network-reachable initiator computing entity to the destination, indicating a capacity to perform offloaded data processing; and receiving a response from a first network-reachable recipient computing entity indicating a capacity to perform offloaded data processing.

The present technology relates to methods and apparatus for computational resource discovery on a network. More particularly, the techniques relate to methods and apparatus for discovery of computational resource discovery along a network route.

Users who have access to devices that have the ability to operate as computers, for example, modern smart mobile (cellular) phones, may have a need for data processing capability that goes beyond what is available in their devices. For example, they may need to make use of large amounts of data, beyond the storage capacity of the device, or they may need to have long, and complex, processing tasks performed (or performed more quickly), beyond the processing power (or speed) of the device. In another example, an application that comprises multiple coordinated tasks may enhance its performance and the user's quality of experience if it has access to processing capability beyond the limited capabilities of a user's single device.

In the current environment, users are typically surrounded by a large number of highly capable computing-capable entities that they either completely own (like in their homes) or a mixture of what they own and do not own (like when they are on the move, or in an office/airport). These computing entities are not always operating to the maximum of their capabilities, and thus have spare capacity that is wasted. In addition, computing-capable entities today provide a variety of capabilities that are often isolated, and so not easily made available to any other reachable systems, unless the user goes through a tedious pairing process to create a connected mesh of pre-formed associations to tie devices and software together. Additionally, it may be difficult to assess the capabilities and level of trustworthiness of other reachable compute entities, via a connection fabric, in order to ad-hoc dispatch to it a computing task, when an initiator device needs that extra help in computing. Thus, while it may be possible to use localised networking (for example, Bluetooth® or other systems, wired or wireless, for connectivity) to pass portions of processing over to other devices, there are difficulties with doing so in a way that assures the effectiveness, efficiency and security of the process.

In a first approach to the many difficulties encountered in operating computing entities to achieve as-needed distributed processing of tasks, the present technology provides a method of operating a network-reachable initiator computing entity for discovery of network-reachable recipient computing entities capable of providing resource of distributed processing, as defined by the appended claims. In a second approach, the present technology provides a method for operating a network-reachable recipient computing entity capable of providing resource for distributed processing, as defined by the appended claims. The present technology thereby provides a system and method for discovery of network-reachable recipient computing entities, as defined by the appended claims.

The method may be computer-implemented, for example in the form of a computer program product that, when loaded into a computer system and executed, causes the computer system to perform the method according to the claims. There is further provided an apparatus comprising a memory and a processor provided with electronic logic circuitry operable to perform the method.

Embodiments will now be described with reference to the accompanying figures of which:

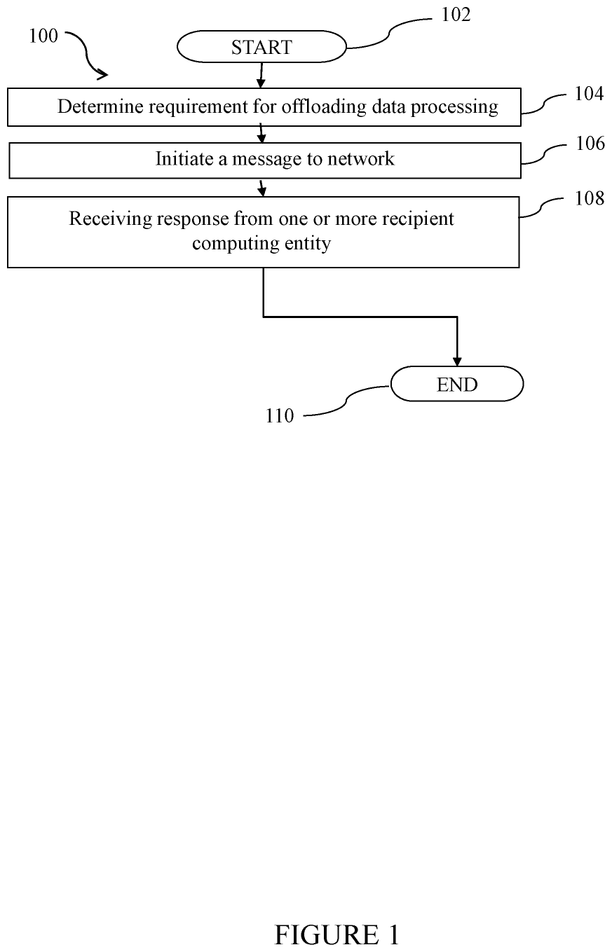

FIG. 1 illustrates a method of operating an initiator computing entity for offloading data processing according to an implementation of the presently described technology;

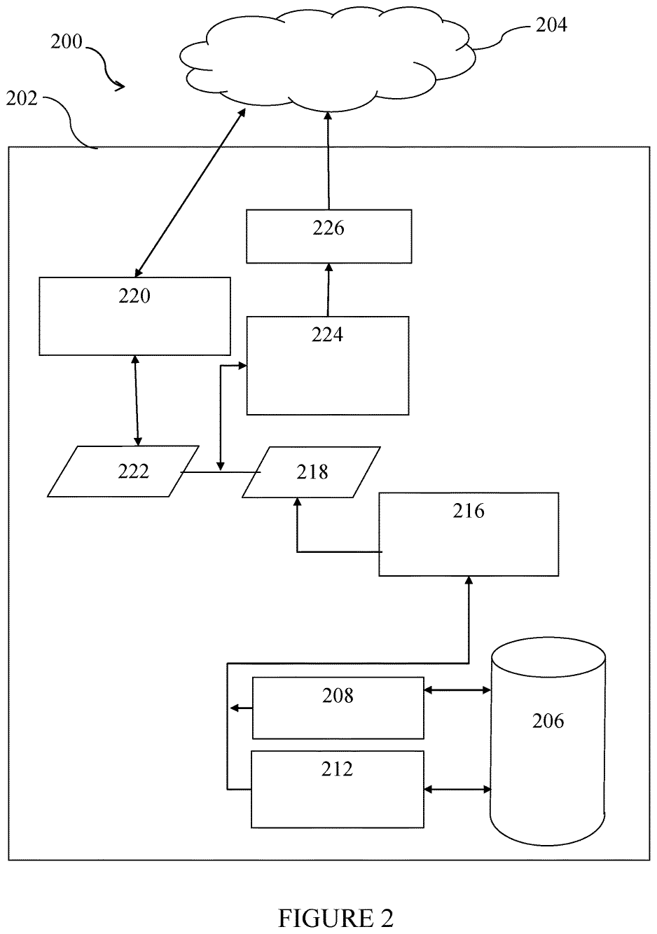

FIG. 2 illustrates a simplified representation of one possible arrangement of electronic circuit components to implement an initiator computing entity operable according to an implementation of the presently described technology;

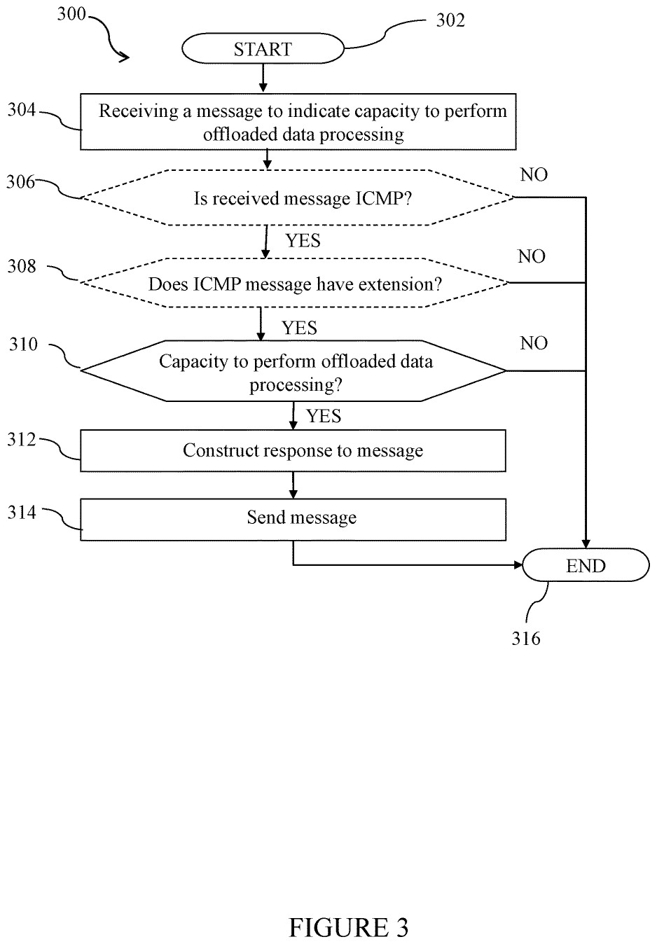

FIG. 3 illustrates a method of operating a recipient computing entity for performing offloaded data processing according to an implementation of the presently described technology;

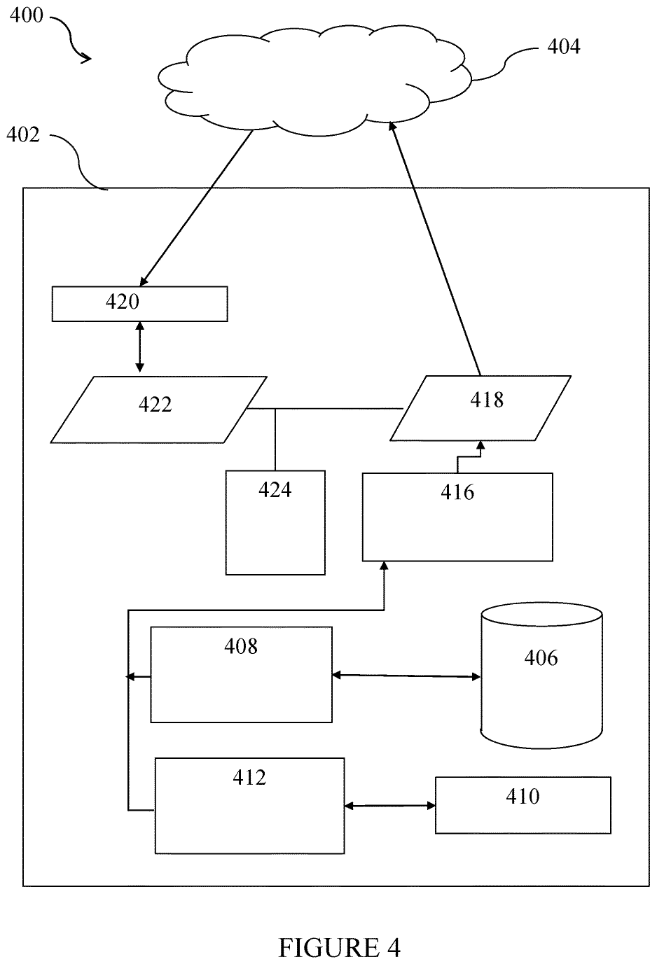

FIG. 4 illustrates a simplified representation of one possible arrangement of electronic circuit components to implement a recipient computing entity operable according to an implementation of the presently described technology; and

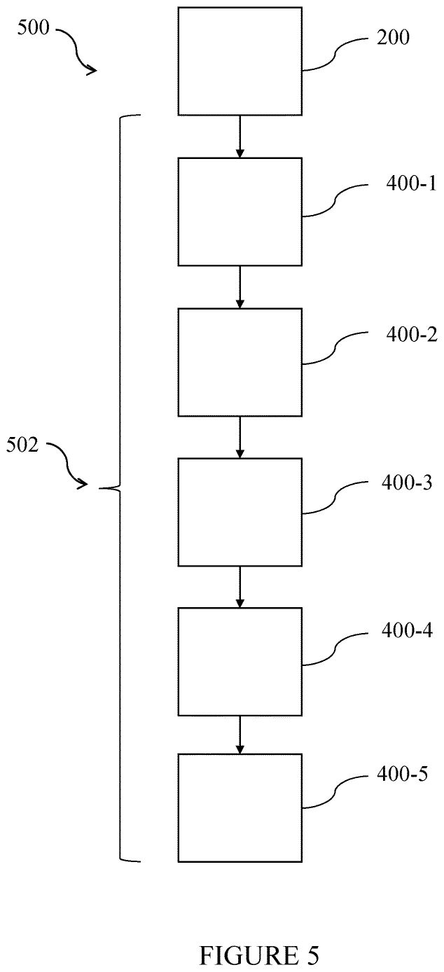

FIG. 5 illustrates an example system arrangement according to an implementation of the presently described technology.

As described above, it is desirable to provide user applications with the opportunity to access additional computing capacity when it is needed, without the need to acquire additional hardware on a permanent basis, and without the need to carry out manual remote device discovery and linking processes. To ensure that any remote processing is performed effectively and efficiently, it is desirable to confirm that any remote device that is considered as a candidate to take on a task genuinely has the capacity to do so.

The present technology operates in a world in which, driven by the Internet of Things trend that incorporates computing capabilities into everyday devices, users are surrounded by computing capacity in many forms. Televisions, watches, home control appliances, telephones, and many other everyday pieces of equipment in addition to conventional computing devices are equipped to intercommunicate and process information. In many cases, because of the use of standard microprocessors with special-purpose software, there may be general-purpose computing capacity built into the devices, a capacity that is often underutilised, and this available capacity could be exploited to beneficial effect by the present technology. At the same time, some devices that are called upon to perform tasks may be “underpowered” to perform those tasks efficiently and quickly, and they could benefit from the use of some of the ambient unused capacity that could be made available to them by the present technology.

Implementations of the present technology thus provide autonomous, dynamic, quick, intelligent, as-required, peer-to-peer discovery of computing entities to dispatch a computation task to, based on the entities' capabilities. A computing entity can be a device such as a hardware platform, a system of linked devices, a virtual machine, or any other technology that can perform a computing task.

The present technology gives the user additional capabilities for a period of time, thus allowing most efficient and effective use of all computing resources available, and removing the need for users to acquire additional permanent computing capacity and then bear the burden of maintaining a large pool of computing power that may be rarely utilized to its full capability. The technology also allows applications to tap into ambient computing power and capacity while the user is on the move.

The effect is achieved by a network-reachable recipient computing entity capable of providing resource for distributed processing and a distributed processing initiator, or network-reachable initiator computing entity, operable to cause discovery of candidate recipient computing entities to enable selection, from a pool of candidate recipient computing entities for distributed processing, according to their capabilities.

One part of the present technology provides a way of operating a network-reachable recipient computing entity that is capable of providing resource for distributed processing to a network-reachable initiator computing entity. The recipient computing entity may be discovered by a discovery process which includes the recipient computing entity determining a processing capability that is available to be provided for distributed processing. The recipient computing entity may be discovered and be comprised in a pool of candidates that are available for selection by the network-reachable initiator computing entity for the reception of offloaded data processing from the network-reachable initiator computing entity. One part of the present technology provides a way of operating a network-reachable initiator computing entity. The network-reachable initiator computing entity first determines a requirement for offloading data processing for a processing task. Having established a requirement for offloading data processing, the network-reachable initiator computing entity polls a network to discover candidate computing entities along a network route or path, which may form a pool of candidate computing entities, that are capable of providing processing capacity perform the offloaded data processing for the processing task. After sending a message on to a network, to proceed along a network route, requesting indications of capacity to perform the offloaded data processing at network-reachable recipient computing entities along the network route, the network-reachable initiator computing entity receives a response from a candidate recipient computing entity capable of providing, at least part of, the required offloaded data processing.

In a possible variant, rather than soliciting discovery of a first candidate recipient computing entity along the network route that meets the requirement for processing offloaded data, the network-reachable initiator computing entity may receive responses from a plurality of network-reachable recipient computing entities along the network route. The network-reachable initiator computing entity may then compare the responses to select the best fit for the data processing to be offloaded-an optimum resource-offering computing entity having characteristics that provide the quickest, and/or least cost, data processing, for example.

It will be immediately clear to one of ordinary skill in the computing art that a computing entity that is operable as a distributed processing initiator, that is a network-reachable initiator computing entity, may also function as a resource-providing or offering computing entity, that is a network-reachable recipient computing entity. In this scenario, the computing entity that operates on one occasion as an initiator to solicit help in completing a computing task, may on another occasion offer its spare computing resource to assist another initiator in completing its computing task. In one variant, the initiator or any of the resource-offering computing entities may be a static device. In all these circumstances, the ambient environment of other processing-capable devices may be static, at least for a time, or may change as portable devices are moved from place to place.

For better understanding, the present technology will be presented with reference to the examples shown in the figures. As will be immediately clear to one of ordinary skill in the computing art, many variants and additional features may be incorporated into the implementation with equal benefit to users of the present technology.

The present technology is operable in situations in which there is a need for collaborative distribution of tasks in a network of reachable devices, where, for example, a computing entity does not have sufficient resource to complete a task alone, but needs to call upon other resource owners to help. In another example, the user quality of experience may be enhanced if an application that comprises multiple tasks can have one or more of the tasks executed by a more computationally powerful device.

The computing entity that starts this collaboration is called an initiator and it can be, for example, a device that a user owns and carries about from place to place, such as a smart phone. The present technology is operable in this situation, when there are computing entities in the network vicinity that may or may not belong to the owner of the compute task initiator, that would potentially be of use in collaboration to complete tasks for which the initiator does not have adequate resource. The present technology addresses the assessment as to whether another computing entity is available and capable of completing a compute task at hand (for example, has spare storage, battery life, processing cycles, or the like).

Throughout the present disclosure, the term “processing capability” should be understood to encompass a number of aspects. For example, the computing entity may have hardware-related performance characteristics such as available memory, memory organisation, processor and queue throughput, processor multitasking capacity, communication and dispatch latency, and the like. “Processing capability” may also encompass a computing entity's estimate of the bandwidth, latency, and energy cost to transfer the data from the initiator to the resource-providing entity and back from the resource-providing entity to the initiator. “Processing capability” may further comprise an estimate of task size or energy consumption requirements, including how a device is powered (mains or battery) and, if applicable, the battery level needed if the recipient computing entity is to be able to perform the task.

In implementations, the initiator and recipient computing entities may be wirelessly networked, or one or both may be statically networked via cable or the like. In one example, a wirelessly networked computing entity may be accessible via Bluetooth®, which is characterised by being a low-energy consumer channel, but which has low communications bandwidth. On the other hand, an entity may be accessible via WiFi®, which consumes more energy, but has a higher bandwidth. Where the task requires little data to be transferred and/or has lax latency requirements the initiator might select the Bluetooth® attached computing entity, otherwise another computing entity with, for example, WiFi® connectivity could be used. Similarly, where devices are dependent upon energy-harvesting or battery power, it is important to assess whether there is sufficient stored power to complete the task. “Processing capability” may also encompass firmware and software support; for example, which tensors are supported, which system libraries are present, and the like. All these will affect any judgment made by the initiator as to the ability of the computing entity to perform the task to meet the initiator's requirements. Many other characteristics that make computing entities more or less suitable for selection will be immediately apparent to one of ordinary skill in the art. In an implementation of the present technology each initiator computing entity may comprise, among other components, an intelligent dispatcher supplied with a set of dispatching policies, a set of costs models encompassing the resource cost of various aspects of task processing, and a neural network for learning and applying the models.

FIG. 1 shows a simplified view of a method 100 of operating a network-reachable initiator computing entity to achieve as-needed distributed processing of tasks according to an implementation of the presently described technology. Method 100 commences at START 102 and at 104, the initiator computing entity determines a requirement for offloading data processing.

The requirement for offloading data processing may be determined or provided by analysing a task to be performed at the initiator computing entity and determining that it needs assistance from one or more resource providing recipient computing entities in order to carry out that task, or in order to optimise the carrying out of the task.

In some embodiments the initiator computing entity may determine the quantum of data storage and processing capability required to perform that task. In some embodiments a processing cost or other processing parameter may be determined by the initiator computing entity to be required to perform the task.

At 106 the initiator computing entity constructs, or initiates, a message to be sent on a network to an end destination. The message provides a request for a response from network-reachable recipient computing entities along the network route, from the network-reachable initiator computing entity to the destination, where the response requested is an indication of capacity to perform offloaded data processing.

The end destination may be a cloud service that is expected to be able to satisfy the request, where the network-reachable recipient computing entities along the network route before the end destination may be able to satisfy the request less expensively or more efficiently than the cloud service. The cloud service at the end destination may therefore provide an option for satisfying the request, should no suitable network-reachable recipient computing entities be discovered along the network route, or should such network-reachable recipient computing entities be unable to satisfy the request less expensively or more efficiently than the cloud service.

The indication of capacity reflects the requirement of a capability for performing offload data processing at a network-reachable recipient computing entity, for example a first network-reachable recipient computing entity. The capability to perform offload data processing may be fulfilled by a recipient computing entity to which the message is sent and received. However, in some embodiments it may be that the recipient computing entity is aware of, potentially nearby, peers, that is, one or more other potential recipient computing entities, that may be capable of performing the data processing to be offloaded. These peers may exist outside of the direct network route along which the message traverses to the destination.

The initiator computing entity therefore receives a response, at 108, from a first network-reachable recipient computing entity indicating a capacity to perform offloaded data processing. The method for discovering recipient computing entities then ends at END 110. It will be clear to one of ordinary skill in the art that END 110 represents the end only of this iteration of the method 100, and further iterations may be performed. Furthermore, beyond the discovery of recipient computing devices, the initiator computing entity may execute further actions to select an appropriate recipient computing device.

The indicated capacity to perform offload data processing may reflect a capability for performing offload data processing at the first network-reachable recipient computing entity, or alternatively, the indicated capacity to perform offload data processing may reflect a capability for performing offload data processing at a second network-reachable recipient computing entity.

In some embodiments, the initiator computing entity may receive a response from each of a plurality of network-reachable recipient computing entities. The plurality of network-reachable recipient computing entities may include the first network-reachable recipient computing entity. Each response from the recipient computing entities indicates a capacity to perform offloaded data processing, either at the network-reachable recipient computing entity from which a respective response was received, or from a network-reachable recipient computing entity from which a respective response was not received. The latter scenario provides that the recipient computing entity may provide information relating to known, potentially nearby, peers, that have the capability to perform the data processing to be offloaded.

Therefore, capacity to perform offload data processing may reflect a capability for performing offload data processing at one or more of the plurality of network-reachable recipient computing entities and/or at one or more network-reachable recipient computing entities that are known to the one or more of the plurality of network-reachable recipient computing entities but to which the message was not, or may not have been, provided.

The message may be an internet control message protocol (ICMP) message, for example as part of a traceroute function where packets are forwarded to network elements, such as routers, involved in transferring the data packets. The message may comprise an extension requesting an indication, from network-reachable recipient computing entities, of capacity to perform offloaded data processing. The message may, for example, comprise details of required processing capability. In addition, the message may comprise details of one or more of required storage capability and cost of data processing.

In some embodiments, the initiator computing entity may parse received recipient computing entity capability output for comparison between recipient computing entity capability output and a recipient computing entity capability requirement to determine whether recipient computing entity capability output achieves some minima determined by recipient computing entity capability requirement. If the recipient computing entity capability output does not achieve some minima determined by recipient computing entity capability requirement, the recipient computing entity is not identified as an appropriate recipient computing entity for performing tasks on behalf of the initiator computing entity. If the recipient computing entity capability output does achieve the minima determined by recipient computing entity capability requirement, the initiator computing entity may immediately select the candidate recipient computing entity, or it may perform further comparisons with recipient computing entity capability output externalised by other recipient computing entities, to determine which offers the best fit for the task. The initiator computing entity may dispatch the task to the selected candidate. The initiator computing entity awaits the end of the dispatched task, which may comprise completion, non-completion or non-completion to the required standard.

In cases where a single application consists of, or can be decomposed into, multiple tasks or workloads, the initiator computing entity will perform the above process for each task of the application. For example, a recipient computing entity may be able to take two of the three tasks of an application and the third task may remain to be run on the initiator computing entity. There may also be reasons why plural tasks of the same application must run on the same recipient computing entity: one could be that the two tasks communicate during their execution, and they require minimum latency for that communication, or the two tasks may need to share data. The present technology is flexible enough to accommodate any such affinity decisions made by the initiator computing entity.

FIG. 2 shows a simplified representation of one possible arrangement of electronic circuit components to implement an initiator computing entity 200 operable according to an implementation of the presently described technology. The initiator computing entity 200, at its highest level, may comprise a virtual machine, but viewed at its lowest level it comprises electronic logic circuitry 202 attachable to a network 204. Network 204 may comprise any of the known forms of network, such as a wide area network, a local area network, a cloud computing infrastructure, a Bluetooth® short-range network, a WiFi® wireless network, and the like. Electronic logic circuitry 202 of the initiator computing entity may be continuously attached to network 204, or its attachment may be intermittent.

Electronic logic circuitry 202 comprises a task store 206. The particular form of data storage used is not material to the operation of the present technology, but it will be clear to one of ordinary skill in the art that it may take any form, provided only that it be suitable for the storage of task data relating to a task that is to be initiated by initiator computing entity 200. Electronic logic circuitry 202 further comprises storage capacity requirement assessor 208 and processing capability/capacity requirement assessor 212, responsible for determining the required storage and computing capabilities necessary to perform the task on behalf of initiator computing entity 200. The storage capacity requirement assessor 208 and processing capability/capacity requirement assessor 212 provide their respective inputs to a recipient computing entity capability requirement builder 216. Responsive to receiving the input from storage capacity requirement assessor 208 and processing capability/capacity requirement assessor 212, recipient computing entity capability requirement builder 216 is operable to build a recipient computing entity capability requirement 218.

Electronic logic circuitry 202 further comprises requester/receiver 220, operable for attachment to and electronic communication with network 204. Requester/receiver 220 is operable to send a query over the network 204 to discover candidates to perform tasks on behalf of initiator computing entity 200. Requester/receiver 220 is further operable to receive at least one recipient computing entity capability output 222 over network 204. Comparator and decision engine 224 then compares a received recipient computing entity capability output 222 with recipient computing entity capability requirement 218. Should the comparison show that recipient computing entity capability output 222 does not meet the minima established by recipient computing entity capability requirement 218, no further actions need to be initiated for that instance of the operation of electronic logic circuitry 202. If recipient computing entity capability output 222 does meet the minima established by recipient computing entity capability requirement 218, comparator and decision engine 224 may then be operable either to select the first available candidate that has met the minima, or may continue processing further recipient computing entity capability outputs 222 to establish a best fit candidate recipient computing entity. Whichever candidate is selected, electronic logic circuitry 202 further comprises a dispatcher 226 operable to dispatch the task to the candidate recipient computing entity for processing.

FIG. 3 shows a simplified view of a method 300 of operating a network-reachable recipient computing entity to achieve as-needed distributed processing of tasks according to an implementation of the presently described technology. The method begins at START 302, and at 304, the recipient computing entity receives a message, the message requesting an indication from the recipient computing entity of capacity to perform offloaded data processing.

In some embodiments the message may be an internet control message protocol message, sent by a network-reachable initiator computing entity, or from another network-reachable recipient computing entity in a network to which the network-reachable recipient computing entity receiving the message belongs. In such an embodiment, at 306, the recipient computing entity determines if the received message is an internet control message protocol message.

When the received message is determined to not be an internet control message protocol message, the recipient computing entity may pass immediately to END 316, without taking any action to communicate with the initiator computing entity. As will be clear to one of ordinary skill in the art, END 316 represents the end of this iteration of the method 300, and further iterations may be performed. Thus, in this implementation, the recipient computing entity may receive the message and decide for itself that its resources are not sufficient to perform requested offloaded data processing on behalf of an initiator computing entity.

When, at 306, the recipient computing entity determines that the received message is an internet control message protocol message, it proceeds to 308, where it is determined whether the internet control message protocol message comprises an extension requesting the indication, from the recipient computing entity, of capacity to perform offloaded data processing.

When the received message is determined to not comprise an extension requesting the indication of capacity to perform offloaded data processing, the recipient computing entity may pass immediately to END 316, without taking any action to communicate with the initiator computing entity. Alternatively, when the received message is determined to not comprise an extension requesting the indication of capacity to perform offloaded data processing, the recipient computing entity may provide a response to the initiator to indicate receipt of the message.

When the received message is determined to comprise an appropriate extension requesting the indication of capacity to perform offloaded data processing, then the recipient computing entity determines, at 310, whether the recipient computing entity has capacity to perform offloaded data processing. The determination of capacity to perform offloaded data processing may require a comparison between requirements provided in the message extension and the capabilities of the recipient computing entity.

When the recipient computing entity is determined to not have capacity to perform the required offloaded data processing, the recipient computing entity may pass immediately to END 316, without taking any action to communicate with the initiator computing entity. Alternatively, when the recipient computing entity is determined to not have capacity to perform the required offloaded data processing, the recipient computing entity may provide a response to the initiator computing entity to signal the lack of capacity to perform the data processing to be offloaded.

When the recipient computing entity is determined to have capacity to perform the required offloaded data processing, then the recipient computing entity constructs, at 312, a response to the received message, the response comprising an indication of capacity to perform offloaded data processing.

The response is then sent to the initiator computing entity at 314.

In the above-described implementation, at 314, the recipient computing entity externalises a capability to provide data processing for data to be offloaded by the initiator computing entity by sending a message on the network to the initiator computing entity thereby potentially entering a candidate pool for selection, by the initiator computing entity, to perform a task on behalf of the initiator computing entity. The recipient computing entity completes the current iteration of the method 300 at END 316. As stated above, it will be clear to one of ordinary skill in the art that END 316 represents the end only of this iteration of the method 300, and further iterations may be performed.

In this way, a recipient computing entity may use its analysis of its available computing facilities to construct and externalise its capability to take on processing of a task on behalf of an initiator computing entity.

FIG. 4 shows a simplified representation of one possible arrangement of electronic circuit components to implement a recipient computing entity 400 operable according to an implementation of the presently described technology. The recipient computing entity, at its highest level, may comprise a virtual machine, but viewed at its lowest level it comprises electronic logic circuitry 402 attachable to a network 404. Network 404 may comprise any of the known forms of network, such as a wide area network, a local area network, a cloud computing infrastructure, a Bluetooth® short-range network, a WiFi® wireless network, ethernet, and the like. Electronic logic circuitry 402 of the resource offering computing entity may be continuously attached to network 404, or its attachment may be intermittent.

Electronic logic circuitry 402 comprises a data store 406 and a processor 410. The particular forms of data storage and processor are not material to the operation of the present technology, but it will be clear to one of ordinary skill in the art that both may take any form, provided only that it be suitable respectively for the storage and the processing of data. Electronic logic circuitry 402 further comprises storage capacity assessor 408 and processing capability/capacity assessor 412, responsible for determining the available storage and computing capabilities and capacity of the electronic logic circuitry 402. The storage capacity assessor 408 and processing capability/capacity assessor 412 provide their respective inputs to a recipient computing entity capability builder 416, which is operable in response to build a recipient computing entity capability output 418.

In some implementations, receiver 420 is operable to receive a message over network 404, the message comprising a request for an indication of capacity 422 to perform offloaded data processing. The request for an indication of capacity 422 may comprise processing capability requirements for the recipient computing entity, where the processing capability requirements may comprise, for example one or more of a processing requirement in terms of a value of millions of instructions per second required at the recipient computing entity, and a processor availability time required at the recipient computing entity. A comparator and decision engine 424 may then compare the recipient computing entity capability output 418 with the request for an indication of capacity 422. In this implementation, should the comparison show that the recipient computing entity capability output 418 does not meet some minima established by the request for an indication of capacity 422, no further actions need to be initiated for this instance of the operation of electronic logic circuitry 402. If the recipient computing entity capability output 418 does meet the minima established by the request for an indication of capacity 422, or if this implementation of the electronic logic circuitry 402 does not comprise receiver 420 and comparator and decision engine 424, electronic logic circuitry 402 is operable to externalise the recipient computing entity capability output 418 over the network 404.

There can be multiple instances of a relationship of one initiator to many workload recipient candidates, and the reachable recipient computing entities form a neighbourhood of the initiator. The home environment is a good example of a neighbourhood, and it has the highest density of computing entities (outside of a datacentre) and the devices around the user have a higher probability of being trusted by the user as they own them.

Any reachable recipient computing entity that uses the present technology will be able to be part of the recipient computing task candidate pool. The pool can be extended to include recipient computing entities outside the user's home, or when they are on the move or at work. As explained above, a computing entity that plays the role of initiator at one time can play the role of a recipient computing entity at another time.

In an initial scenario, a boundary may be established or provided, limiting the distance from the initiator computing entity that a recipient computing entity may be located. The initiator computing entity may establish a scenario boundary to delimit a pool of candidate network-reachable recipient computing entities for offloaded data processing.

If an initiator computing entity does not receive adequate responses from a first set of potential candidate recipient computing entities within its current scenario boundary, it may extend the scope of its query by expanding the current scenario boundary to include more of the reachable recipient computing entities further removed in the network from the initiator computing entity.

Sets of reachable recipient computing entities may form into neighbourhoods, and the parameters defining neighbourhoods may be stored and reused by the computing entities when they are acting as initiators. This notion of neighbourhoods introduces the sense of dynamic neighbourhoods that change according to where the user or initiator computing entity is, such as home, living room, office, car, train, etc. In this case, the present technology, by using an external learner neural network can develop and learn the different scenarios according to the initiator computing entity's neighbourhood, thereby enabling the scenarioizing of the operations of the initiator, thus saving time in the decision-making process when determining which computing entities to dispatch tasks to.

Similarly, the operation of a neural network allows the use of one application where computing tasks start from the initiating device to vary according to the way the individual user interacts with it, hence enabling personalisation. The neural network learns how an application is used in the living room neighbourhood by one person as opposed to another person, by observing how the dispatcher of the initiating device dispatches computing tasks to the available workload recipients in the pool associated with, for example, the living room neighbourhood.

The area for the selection of the best recipient computing entity starts from where the user is (and usually initiated by the device they are using), but although the technology may make use of the neighbourhood concept, it may also be implemented in a location independent manner, and thus a neighbourhood can subsequently expand to any other reachable computing node, based on the priorities of the workload to be executed: latency, privacy, energy consumption and the like.

FIG. 5 illustrates a system 500 for computational resource discovery along a network 502. Such a system may comprise a network-reachable initiator computing entity 200 and one or more network-reachable recipient computing entities 400 configured to carry out the previously described methods. For example, in FIG. 5 there are five network-reachable recipient computing entities 400-1, 400-2, 400-3, 400-4, 400-5 configured to carry out previously described methods, each representing a hop in the network. In one example, the first recipient computing entity 400-1 may be a gateway, the second recipient computing entity 400-2 may be a 5G Multi-Access Edge Computing (MEC) data centre, the third recipient computing entity 400-3 may be a telecommunications operator, the fourth recipient computing entity 400-4 may be a local data centre, and the fifth recipient computing entity 400-5 may be a regional data centre.

When a network-reachable recipient computing entity 400 of the one or more network-reachable recipient computing entities 400 receives the message sent from the network-reachable initiator computing entity 200 but does not have capacity to perform data processing which is to be offloaded or is unable to process the message, the network-reachable recipient computing entity forwards the message on to the next network-reachable recipient computing entity 400 in the network without providing any details of capacity to perform offloaded data processing to the network-reachable initiator computing entity.

The network-reachable initiator computing entity 200 may receive responses from one or more network-reachable recipient computing entities 400 indicating a capacity at each respective network-reachable recipient computing entity 400 to perform data processing which is intended to be offloaded. The network-reachable initiator computing entity 200 may then select a network-reachable recipient computing entity 400 to perform the offloaded data processing.

In various implementations, the present technology may fall within the scenarios according to the following listings of processing steps. The listings use the following abbreviations:
1. Distributed processing initiator (DPI)
2. Distributed processing initiator's capability requirement (DPI_R)
3. Distributed processing recipient (DPR)
4. Distributed processing recipient capability output (DPR_O)
   Scenario 1 is the simpler of the implementations, and may be useful in keeping the number of communication interactions low because the DPI capability requirement is not transmitted.

Scenario 1: DPI capability requirement DPI_R stays at the DPI. The DPR always sends its DPR_O.
1. DPI->generates capability requirement (DPI_R)
2. DPI->requests recipient capability output DPR_O from DPR
3. DPR->generates recipient capability output (DPR_O)
4. DPR->sends DPR_O to DPI
5. DPI->Analyses DPI_R and DPR_O to determine which DPR to use.
   Scenario 2 is the more complex, but advantageously allows a reduction in the number of candidates that respond to the DPI's query.

Scenario 2: DPI capability requirement DPI_R is sent to DPR. The DPR may or may not send its DPR_O to the DPI depending on the overlap between the DPR_O and DPI_R.
1. DPI->generates capability requirement (DPI_R)
2. DPI->sends its capability requirement (DPI_R) to DPR
3. DPR->generates recipient capability output (DPR_O)
4. DPR->potentially analyses its DPR_O and DPI_R to see if there is overlap
5. DPR->sends DPR_O to DPI if there is a good overlap between the DPR_O and DPI_R; otherwise potentially the DPR indicates that it cannot perform the task, or simply does not respond with an attempt to join the candidate pool. 6. DPI->Analyses DPI_R and received DPR_Os to determine which DPR to use.

The flexibility of this technology allows multiple different scenarios of operation and is not restricted to the two scenarios illustrated above. Other scenarios could include but are not limited to, for example, the DPI sending its DPR_O to the DPI only as a response to its availability. In another example, the DPI sends a restricted DRI_R to reachable DRPs. Because the present technology is operable at the infrastructure level, scenarios can be covered and expressed by an extendable protocol that is suitable for modification to suit the efficacy, security, reliability and integrity requirements of the owners of the devices.

As will be appreciated by one skilled in the art, the present technique may be embodied as a system, method or computer program product. Accordingly, the present technique may take the form of an entirely hardware embodiment, an entirely software embodiment, or an embodiment combining software and hardware. Where the word “component” is used, it will be understood by one of ordinary skill in the art to refer to any portion of any of the above embodiments. Furthermore, the present technique may take the form of a computer program product embodied in a non-transitory computer readable medium having computer readable program code embodied thereon. The computer readable medium may be a computer readable storage medium. A computer readable medium may be, for example, but is not limited to, an electronic, magnetic, optical, electromagnetic, infrared, or semiconductor system, apparatus, or device, or any suitable combination of the foregoing.

Computer program code for carrying out operations of the present techniques may be written in any combination of one or more programming languages, including object-oriented programming languages and conventional procedural programming languages.

For example, program code for carrying out operations of the present techniques may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language such as Verilog™ or VHDL (Very high-speed integrated circuit Hardware Description Language).

The program code may execute entirely on the user's computer, partly on the user's computer and partly on a remote computer or entirely on the remote computer or server. In the latter scenario, the remote computer may be connected to the user's computer through any type of network. Code components may be embodied as procedures, methods or the like, and may comprise sub-components which may take the form of instructions or sequences of instructions at any of the levels of abstraction, from the direct machine instructions of a native instruction-set to high-level compiled or interpreted language constructs.

It will also be clear to one of skill in the art that all or part of a logical method according to embodiments of the present techniques may suitably be embodied in a logic apparatus comprising logic elements to perform the steps of the method, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored using fixed carrier media.

In one alternative, an embodiment of the present techniques may be realized in the form of a computer implemented method of deploying a service comprising steps of deploying computer program code operable to, when deployed into a computer infrastructure or network and executed thereon, cause said computer system or network to perform all the steps of the method.

In a further alternative, an embodiment of the present technique may be realized in the form of a data carrier having functional data thereon, said functional data comprising functional computer data structures to, when loaded into a computer system or network and operated upon thereby, enable said computer system to perform all the steps of the method.

It will be clear to one skilled in the art that many improvements and modifications can be made to the foregoing exemplary embodiments without departing from the scope of the present technique.

1. A method of operating a network-reachable initiator computing entity, comprising:
determining a requirement, at the initiator computing entity, for offloading data processing;
initiating a message, to be sent on a network to a destination, requesting a response from network-reachable recipient computing entities along the network, from the network-reachable initiator computing entity to the destination, indicating a capacity to perform offloaded data processing; and
receiving a response from a first network-reachable recipient computing entity indicating a capacity to perform offloaded data processing.

2. A The method of operating a network-reachable initiator computing entity according to claim 1, wherein the capacity to perform offload data processing reflects a capability for performing offload data processing at the first network-reachable recipient computing entity.

3. The method of operating a network-reachable initiator computing entity according to claim 1, wherein the capacity to perform offload data processing reflects a capability for performing offload data processing at a second network-reachable recipient computing entity.

4. The method of operating a network-reachable initiator computing entity according to claim 2, comprising:
comparing the capability for performing offload data processing with the requirement;
selecting a candidate network-reachable recipient computing entity based on the comparison; and
dispatching the offloaded data processing to the selected candidate.

5. A The method of operating a network-reachable initiator computing entity according to claim 1, the method comprising:
receiving a response from each of a plurality of network-reachable recipient computing entities, the plurality of network-reachable recipient computing entities including the first network-reachable recipient computing entity, each response indicating a capacity to perform offloaded data processing.

6. A The method of operating a network-reachable initiator computing entity according to claim 5, wherein the capacity to perform offload data processing reflects a capability for performing offload data processing at the network-reachable recipient computing entity from which a respective response was received.

7. A The method of operating a network-reachable initiator computing entity according to claim 5 wherein the capacity to perform offload data processing reflects a capability for performing offload data processing at a network-reachable recipient computing entity from which a respective response was not received.

8. A The method of operating a network-reachable initiator computing entity according to claim 6 comprising:
comparing the capability for performing offload data processing of each of the network-reachable recipient computing entities with the requirement;
selecting a candidate network-reachable recipient computing entity based on the comparison; and
dispatching the offloaded data processing to the selected candidate.

9. The method of operating a network-reachable initiator computing entity according to claim 4 in which the comparison comprises determining if the capability for performing offload data processing achieves a minima determined by the requirement.

10. A The method of operating a network-reachable initiator computing entity according to claim 1, wherein the message is an internet control message protocol message comprising an extension requesting an indication, from network-reachable recipient computing entities, of capacity to perform offloaded data processing.

11. A The method of operating a network-reachable initiator computing entity according to claim 1, wherein the message comprises details of required processing capability.

12. The method of operating a network-reachable initiator computing entity according to claim 11, wherein the message comprises details of one or more of required storage capability and cost of data processing.

13. A The method of operating a network-reachable initiator computing entity according to claim 1, comprising establishing a scenario boundary to delimit a pool of candidate network-reachable recipient computing entities for offloaded data processing.

14. The method of operating a network-reachable initiator computing entity according to claim 1, further comprising:
cooperating with a network-reachable recipient computing entity to:
request an indication from the network-reachable recipient computing entity of capacity to perform
when the network-reachable recipient computing entity is determined to have capacity to perform offloaded data processing, receive a response to the received message, the response comprising an indication of capacity to perform offloaded data processing.

15. An apparatus comprising:
a data store,
a processor, and
dedicated electronic logic circuitry to:
determine a requirement, at a network-reachable initiator computing entity, for offloading data processing;
initiate a message, to be sent on a network to a destination, requesting a response from network-reachable recipient computing entities along the network, from the network-reachable initiator computing entity to the destination, indicating a capacity to perform offloaded data processing; and
receive a response from a first network-reachable recipient computing
entity indicating a capacity to perform offloaded data processing.

16. The apparatus according to claim 15, wherein the capacity to perform offload data processing reflects a capability for performing offload data processing at the first network-reachable recipient computing entity.

17. The apparatus according to claim 15, further comprising dedicated electronic logic circuitry to:
compare the capability for performing offload data processing with the requirement;
select a candidate network-reachable recipient computing entity based on the comparison; and
dispatch the offloaded data processing to the selected candidate.

18. A computer program product stored on a non-transitory computer-readable medium comprising computer program code to, when loaded into a computer system and executed thereon, cause said computer system to:
determine a requirement, at a network-reachable initiator computing entity, for offloading data processing;
initiate a message, to be sent on a network to a destination, requesting a response from network-reachable recipient computing entities along the network, from the network-reachable initiator computing entity to the destination, indicating a capacity to perform offloaded data processing; and
receive a response from a first network-reachable recipient entity indicating a capacity to perform offloaded data processing.

19. The computer program product according to claim 18, wherein the capacity to perform offload data processing reflects a capability for performing offload data processing at the first network-reachable recipient computing entity.

20. (canceled)

21. A computer program product according to claim 18, further comprising computer program code to, when loaded into a computer system and executed thereon, cause said computer system to:
compare the capability for performing offload data processing with the requirement;
select a candidate network-reachable recipient computing entity based on the comparison; and
dispatch the offloaded data processing to the selected candidate.

22. (canceled)

23. (canceled)
